(19) United States
(12) Patent Application Publication
(10) Pub. No.: US 2019/0045084 A1
(43) Pub. Date: Feb. 7, 2019

(54) PRINTER WITH SPECTROPHOMETRIC MEASUREMENT

(71) Applicant: HP INDIGO B.V., Amstelveen (NL)

(72) Inventors: Nir Guttman, Ness Ziona (IL); Lena Gurevich, Ness Ziona (IL); Gregory Braverman, Ness Ziona (IL)

(73) Assignee: HP INDIGO B.V., Amstelveen (NL)

(21) Appl. No.: 16/073,029

(22) PCT Filed: May 31, 2016
(86) PCT No.: PCT/EP2016/000886

§ 371 Date: Jul. 26, 2018

(51) Int. Cl. H04N 1/60; G01J 3/52; G01J 3/50; H04N 1/00

(52) U.S. Cl. CPC H04N 1/603; G01J 3/524; H04N 1/00092; H04N 1/00034; G01J 3/50

(57) ABSTRACT

Printing with a first print engine on a front side of a substrate, and a second print engine on the rear side of the substrate, wherein a first spectrophotometer sensor and a second spectrophotometer sensor are used for spectrophotometric measurements on the blank front and rear sides of the substrate, and producing correction data which represent a deviation of the spectrum representing output signals from the first and second sensors, and wherein a correction derived from the correction data compensates a deviation in the spectral reflectivity of at least one of the front side and the rear side of the substrate. Cross-calibrating the first and second sensors is by processing the spectrum representing output signals of the sensors from identical spectrophotometric measurements.

### BACKGROUND

Spectrophotometric measurement is used for color calibration so that reproduced colors match corresponding target values as well as possible. Spectrophotometric measurement and color calibration is useful for high quality color printers.

In color management, color profiles are used to describe the color attributes of a particular color capturing or color reproducing device, such as a printer, by defining a mapping between the device source color space or the target color space and a profile connection space as, e.g. CIELAB or CIEXYZ. Some manufacturers provide profiles for their products, and some products allow an end-user to generate his own color profiles by the use of a colorimeter or spectrophotometer.

Some printers have a first print engine to print on a front side of a substrate and a second print engine to print on the rear side of the substrate, wherein the printer has a common feeder to feed the substrate to the first and second print engines, so that the first print engine is to print on the front side of the substrate which is fed from the common feeder, and the second print engine is to print on the rear side of the substrate.

### BRIEF DESCRIPTION OF THE DRAWINGS

Examples will be described, by way of example only, with reference to the accompanying drawings in which corresponding reference numerals indicate corresponding parts and in which:

FIG. 1 is a schematic illustration of an example printer;

FIG. 2 is a graphical representation of example output signals representing spectra of light received by first and second spectrophotometer sensors in an example spectrophotometric measurement used in the example printer;

FIG. 3 is an enlarged partial graphical representation of example output signals representing spectra of light received by first and second spectrophotometer sensors, and of a corrected measurement signal; and

FIG. 4 a) and b) illustrate further examples in which sensors of a spectrophotometric measurement system include a light source.

### DETAILED DESCRIPTION

Some printers have a first print engine to print on a front side of a substrate and a second print engine to print on the rear side of the substrate. Such a printer often has a common feeder to feed the substrate to the first and second print engines, so that the first print engine prints on the front side of the substrate which is fed from the common feeder, and the second print engine prints on the rear side of the substrate.

An example printer implements spectrophotometric measurement, in which first and second spectrophotometer sensors receive light from the substrate and produce output signals which represent a spectrum of the light received.

In an example printer the first sensor is for spectrophotometric measurement of the front side of the substrate and the second sensor is for spectrophotometric measurement of the rear side of the substrate, and the spectrophotometric measurements are performed on the blank front and rear sides of the substrate. The output signals of the first and second sensors represent the spectral reflectivity of the front side and the rear side of the substrate, respectively. For the sake of brevity and clarity, the output signals of the sensors that represent the spectrum of light received are referred to herein simply as “output signals”.

According to an example, a printer has a first print engine to print on a front side of a substrate and a second print engine to print on the rear side of the substrate, and a first spectrophotometer sensor and a second spectrophotometer sensor, wherein the sensors are for spectrophotometric measurement by receiving light reflected from the substrate and to produce output signals which represent a spectral reflectivity of the substrate, wherein the first sensor is for spectrophotometric measurement of the front side of the substrate and the second sensor is for spectrophotometric measurement of the rear side of the substrate, and wherein the spectrophotometric measurements are performed on the blank front and rear sides of the substrate. A processing unit is to receive the output signals of the first and second sensors, to produce correction data which represent a deviation between the output signals from the first and second sensors, and to apply a correction derived from the correction data on at least one of the first and second print engines, so that a deviation in the spectral reflectivity of at least one of the front side and the rear side of the substrate is compensated by the first and second print engines, wherein the first and second sensors are cross-calibrated by the processing unit from output signals of the sensors from identical spectrophotometric measurements.

In an example, the output signals of the first and second spectrophotometer sensors are processed in a processing unit. Processing the output signals of the first and second spectrophotometer sensors by the processing unit includes producing correction data which represent a deviation between the output signals from the first and second spectrophotometer sensors, applying a correction derived from the correction data on at least one of the first and second print engines, so that a deviation in the spectral reflectivity of at least one of the front side and the rear side of the substrate is compensated by the first and second print engines. Similar as the output signals of the first and second sensors represent the spectral reflectivity of the front side and the rear side of the substrate, respectively, the correction data represent the spectral deviation between the output signals from the first and second spectrophotometer sensors.

In a printer which has a first print engine to print on a front side of a substrate and a second print engine to print on the rear side of the substrate the spectral reflectivity of the front side and the rear side of the substrate may be different. Spectrophotometric measurements can be used for compensating the deviation in the spectral reflectivity of the front side and the rear side of the substrate.

Two different spectrophotometric measurements of a printable area may be different, even if it is the same printable area. Such differences can be due to various operational differences, such as variations in self-calibrations, different mechanical support systems, or different illuminating conditions. Avoiding such operational differences can lead to a decrease in color differences perceived by the end user. According to an example, the first and second sensors are cross-calibrated by processing the output signals of the sensors from identical spectrophotometric measurements, and the spectrophotometric measurements for compensating the deviation in the spectral reflectivity of the front side and the rear side of the substrate are performed by the cross-calibrated sensors.

According to an example method printing is with a first print engine to print on a front side of a substrate, and a second print engine to print on the rear side of the substrate, wherein a first spectrophotometer sensor and a second spectrophotometer sensor are used for spectrophotometric measurement by receiving light reflected from the substrate, and to produce output signals which represent a spectral reflectivity of the substrate. The first sensor performs spectrophotometric measurement of the front side of the substrate, and the second sensor performs spectrophotometric measurement of the rear side of the substrate, and the spectrophotometric measurements are performed on the blank front and rear sides of the substrate. A processing unit receives the output signals of the first and second sensors and produces correction data which represent a deviation between the output signals from the first and second sensors, and a correction derived from the correction data is applied on at least one of the first and second print engines, so that a deviation in the spectral reflectivity of at least one of the front side and the rear side of the substrate is compensated by the first and second print engines. The method further includes cross-calibrating the first and second sensors by processing the output signals of the sensors from identical spectrophotometric measurements, and wherein the spectrophotometric measurements for compensating the deviation in the spectral reflectivity of the front side and the rear side of the substrate are performed by the cross-calibrated sensors.

In various examples the sensors include a light source.

In various examples the sensors include light-receiving areas which form a circle or a ring around a centrally arranged light source so that the light source is surrounded by the light-receiving area.

In an example the light from the light source is directed in orthogonal direction (0°) relative to the object, or the surface of the object, on which a spectrophotometric measurement is to be performed, e.g. on a surface of a printing substrate. The light incident on the object is then reflected back to the light-receiving area of the sensor. In some examples, the light is reflected at a an angle relative to a direction normal to the surface of the object. In some examples the angle is acute, e.g., less than or equal to 45°. In such examples, the light-receiving area of the sensor receives light emitted from the central light source and reflected by the substrate at a range of reflection angles approximately defined by the dimensions of the formation (e.g., the radius of the ring or circle) which defines the light-receiving area and the distance between substrate and sensor.

In some example implementations, spectrophotometric measurements may include receiving reflection value measurements corresponding to a reference substrate from the two sensors of the spectrophotometer measurement system. In such implementations, the reference substrate can include a white surface with a known reflectance profile (e.g., a reflectance profile that evenly reflects light across a particular spectrum, such as the visible spectrum). In such implementations, one sensor can act as a reference. An analysis may be performed on the measured values, and a corresponding correction may be generated to match the measurements of the sensors. In some example implementations the measurements of the non-reference sensor can be corrected to match measurements of the reference sensor.

One example of spectrophotometric measurement includes measuring spectral reflectivity (reflectance) of a given substrate using two spectrophotometer sensors, wherein one is a reference sensor and one is a sensor which is to be corrected. A correction is calculated using spectrophotometric measurements from both sensors, and applied to measurements of the sensor to be corrected. Such a calibration is, for example, also performed when a sensor is replaced and/or any mechanical adjustments are made to any of the corresponding mechanical systems.

According to one example the correction is be calculated as follows:

The reflectance values <R_reference_i> and <R_corrected_i> of a given substrate are measured using the reference and sensors to be corrected of the spectrophotometer system. Based on the reflectance values, the ratio between the two measurements is calculated:

<R_correction_i>=<R_reference_i>/<R_corrected_i>
wherein i=1 . . . n.

The resulting factor is then applied to measurements from the corrected spectrophotometer sensor.

Automatic or continuous correction algorithms may be used for improved correlation between the sensors. Such correction may help overcome possible mechanical and instrumental failures in the spectrophotometer measurement systems, such as bad self-calibration or inherent differences between the two devices.

In some examples the cross-calibrating includes producing the correction data from a ratio of the output signals of the second sensor and the output signals of the first sensor, and applying the ratio as a correction factor to the output signals of the first sensor (or vice-versa).

In some examples the cross-calibrating includes producing the correction data from a difference between the output signals of the second sensor and the output signals of the first sensor, and adding a correction derived from the difference to the output signals of the first sensor (or vice-versa).

In some examples producing the correction data and applying the correction derived from the correction data is performed automatically.

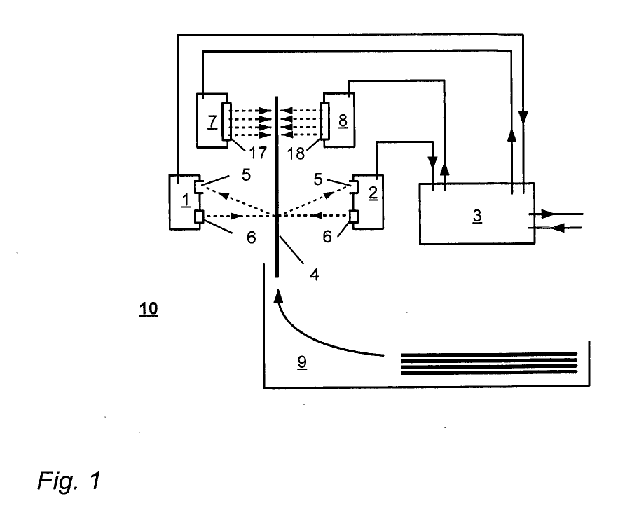

Now refer to FIG. 1, which illustrates a schematic view of an example printer 10 for printing on a printable substrate 4.

The example printer 10 has a first print engine 7 and a second print engine 8 to print on a the substrate 4. The first print engine 7 has a printing head 17 to print on a front side of a substrate 4 and the second print engine 8 has a printing head 18 to print on the rear side of the substrate. In FIG. 1 the first print engine 7 and the second print engine 8 are shown on opposite sides of the substrate 4 for illustrating purpose, but they can also be off-set to each other.

The substrate 4 is fed to the first and second print engines 7, 8 by a common feeder 9. As an example the substrate 4 is provided in the common feeder 9 in the form of a stack of paper sheets.

The example printer 10 has a first spectrophotometer sensor 1 and a second spectrophotometer sensor 2, wherein the sensors 1, 2 are for spectrophotometric measurement by receiving light reflected from the substrate 4 and to produce output signals which represent a spectral reflectivity of the substrate 4. The first sensor 1 is for spectrophotometric measurement of the front side of the substrate 4 and the second sensor 2 is for spectrophotometric measurement of the rear side of the substrate 4. The spectrophotometric measurements are performed on the blank front and rear sides of the substrate 4. In FIG. 1 also the first sensor 1 and a second sensor 2 are shown on opposite sides of the substrate 4 for illustrating purpose, but they can also be off-set to each other.

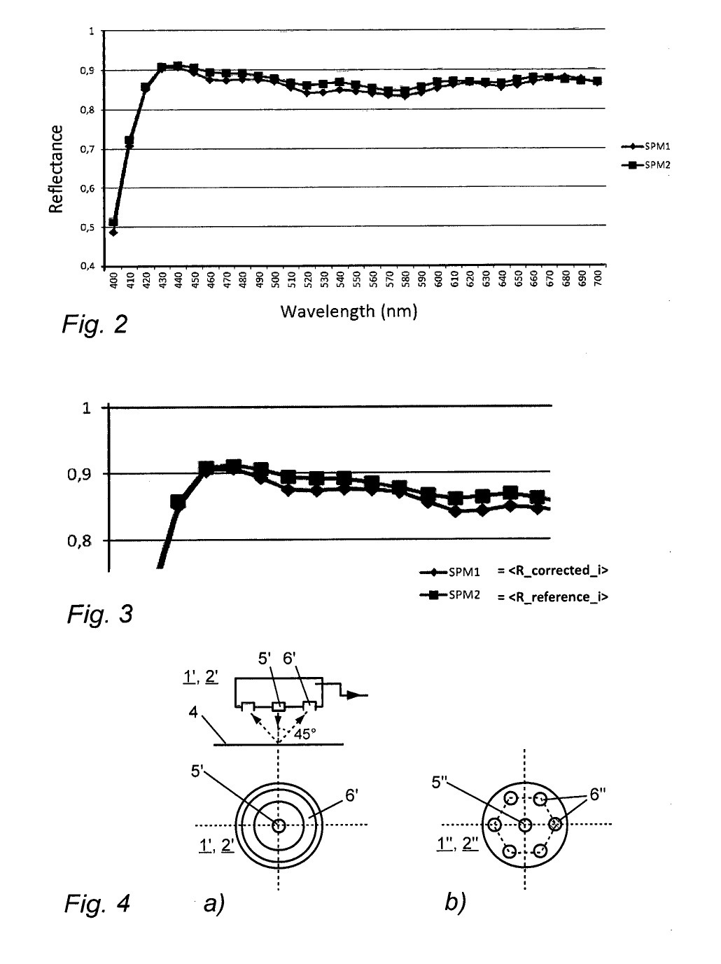

The first spectrophotometer sensor 1 and the second spectrophotometer sensor 2 included in the printer 10 receive light from the printable substrate 4. Light sources 5 which are provided in the sensors 1, 2 illuminate the printable substrate 4 so that light from the substrate 4 is reflected and received by light-receiving areas 6 of the sensors 1, 2, respectively. The first and second sensors 1, 2 produce output signals SPM1, SPM2 which each represent the spectrum of the light received, as will be explained later with reference to FIGS. 2 and 3. The processing unit 3 receives output signals SPM1, SPM2 of the first and second sensors 1, 2.

The processing unit 3 receives the output signals of the first and second sensors 1, 2, to produce correction data which represent a deviation between the output signals from the first and second sensors 1, 2 corresponding to a deviation in the spectral reflectivity of at least one of the front side and the rear side of the substrate 4, and applies a correction derived from the correction data on at least one of the first and second print engines 7, 8, so that the deviation in the spectral reflectivity is compensated.

In an example, the first and second sensors 1, 2 are cross-calibrated by the processing unit 3 from output signals of the sensors 1, 2 from identical spectrophotometric measurements.

In an example, the cross-calibrating of the sensors 1, 2 by the processing unit is by processing the output signals of the first and second sensors 1, 2 by spectrophotometric measurement of a specimen substrate 4 which has identical spectral reflectivities on the front side and the rear side. According to another example, the cross-calibrating of the sensors 1, 2 can be by processing the output signals of the first and second sensors 1, 2 which are produced by measurements which include turning round the substrate 4 so that the spectrophotometric measurements by the sensors 1, 2 are performed successively from the same surface of the substrate 4.

According to one example, the processing unit 3 compensates the relative deviation in the spectral reflectivity of the front side from the spectral reflectivity of the rear side of the substrate 4.

According to another example, the processing unit 3 compensates at least one of a deviation of the spectral reflectivity of the front side of the substrate 4 from a reference spectral reflectivity and a deviation of the spectral reflectivity of the rear side of the substrate 4 from a reference spectral reflectivity.

In an example spectrophotometric measurement system as illustrated in the example printer 10 of FIG. 1 the light from the light source 5 is directed in orthogonal direction (0°) to the object 4 on which the measurement is performed, e.g. on the surface of the printing substrate 4 or similar. The light is reflected at an angle back to the light-receiving area 6 of the respective sensor 1, 2, so that the light emitted from the light source 5 and reflected by the object or substrate 4 is received by the light-receiving area 6 at a particular reflection angle.

So far, the processing unit 3 is to receive the output signals SPM1, SPM2 of the first and second spectrophotometer sensors 1, 2 and to produce a corrected measurement signal on the basis of the output signals of both the first and second spectrophotometer sensors 1, 2 so that so that a deviation in the spectral reflectivity of the front side and the rear side of the substrate 4 is compensated.

In an example the processing unit 3 is further to produce correction data which represent a deviation between the output signals SPM1, SPM2 from the first and second spectrophotometer sensors 1, 2 for the purpose of cross-calibrating the sensors 1, 2. The processing unit 3 produces the corrected measurement signal by applying a correction derived from the correction data on one or both of the output signals SPM1 of the first sensor 1 and the output signals SPM2 of the second sensor 2.

FIG. 2 illustrates an example of the output signals SPM1 of the first spectrophotometer sensor 1 and the output signals SPM2 of the second spectrophotometer sensor 2. The signals SPM1 and SPM2 represent the spectral reflectivity or reflectance of the substrate 4 as measured by the first and second spectrophotometer sensors 1, 2. As can be seen in FIG. 2, and more in detail in is an enlarged partial graphical representation of the same reproduced in FIG. 3, there is a deviation between the output signals SPM1 of the first sensor 1 and the output signals SPM2 of the second sensor 2.

In an example, the processing unit 3 produces the correction data as a ratio of the output signal SPM2 of the second spectrophotometer sensor 2 and the output signals SPM1 of the first spectrophotometer sensor 1, and produces the corrected measurement signal by applying the ratio as a correction factor on the output signals SPM1 of the first sensor 1. The correction may be generated by using the second sensor 2 as the corrected sensor.

According to one example the correction can be calculated as follows:

The spectral reflectivity values <R_reference_i> and <R_corrected_i> of a given substrate is measured using both sensors 1, 2 of the spectrophotometer system, wherein

SPM1=<R_corrected_i>, i=1 . . . n, and

SPM2=<R_reference_i>, i=1 . . . n,
wherein
<R_reference_i> denote the reflectivity values of one of the sensors which is used as a reference sensor, and
<R_corrected_i> denote the reflectivity values of the other of the sensors which is the sensor which is to be corrected.

Based on these reflectivity values the ratio between the two measurements is calculated:

<R_correction_i>=<R_reference_i>/<R_corrected_i>

The resulting factor is then applied to measurements from the spectrophotometer sensor to be corrected. In the example shown in FIGS. 2 and 3, the output signal from the second spectrophotometer sensor 2 is the reference, and the output signal from the first spectrophotometer sensor 1 is being corrected.

In another example, the processing unit 3 is to produce the correction data as a difference between the output signals SPM2 of the second spectrophotometer sensor 2 and the output signals SPM1 of the first spectrophotometer sensor 1, and produces the corrected measurement signal by adding a correction derived from the difference to the output signals SPM1 of the first spectrophotometer sensor 1. The correction may also include correcting the output signals SPM2 from the second spectrophotometer sensor 2 as above for the output signal SPM1 from the first spectrophotometer sensor 1.

According to still another example, the processing unit 3 is adapted to produce the correction data as an intermediate value between the output signals SPM2 of the second spectrophotometer sensor 2 and the output signals SPM1 of the first spectrophotometer sensor 1, and produces the corrected measurement signal by applying an intermediate correction to the output signals SPM1 and SPM2 of both the first and second sensors 1 and 2 so that both sensors are calibrated to a new intermediate spectral reflectivity which is between the two curves shown in FIGS. 2 and 3.

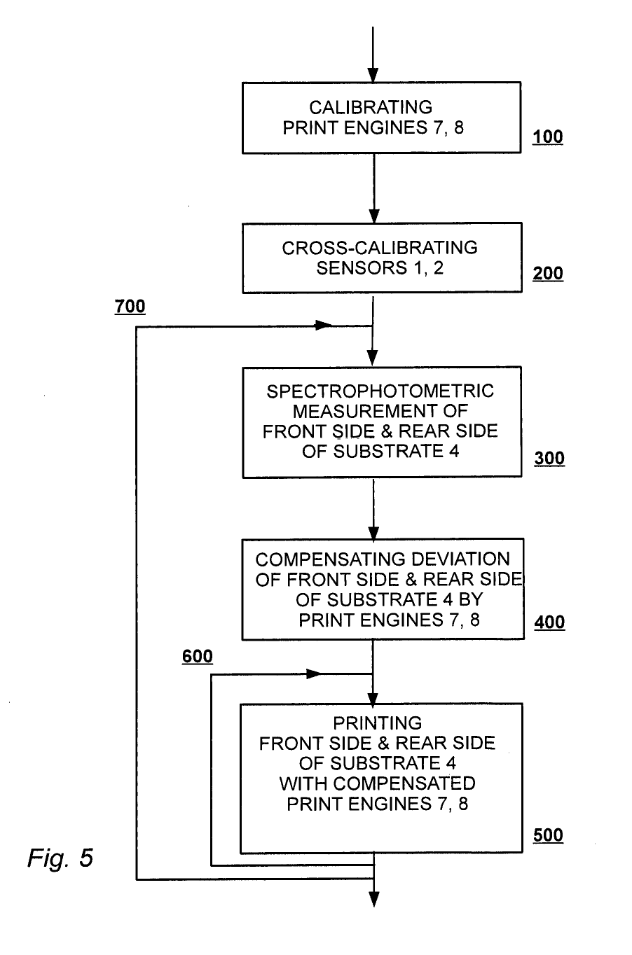

FIG. 4 a) and b) illustrate examples in which the sensors 1′, 2′; 1″, 2″ include light-receiving areas 6′, 6″ which are arranged around a centrally arranged light source 5′, 5″. In the example of FIG. 4a) the light-receiving area 6′ is in the form of a circular ring. In the examples illustrated in FIG. 4 a) and b), the light-receiving area 6′ is centered on a centrally arranged light source 5′ so that the light source 5′ is surrounded by the light-receiving area 6′. In the example of FIG. 4b) the light-receiving area 6″ is in the form of separate light receptors which are disposed in a circle or a ring around and the centrally arranged light source 5″.

In an example as exemplified in the upper part of FIG. 4a), the light from the light source 5′ is directed in orthogonal direction (0°) to the object 4 on which the measurement is performed, e.g. on a surface of a printing substrate, and the light is reflected under an angle of about 45° back to the light-receiving area 6′ of the sensor 1′, 2′. Hence, the light-receiving area 6′ receives light emitted from the central light source 5′ and reflected by the object or substrate 4 at a range of reflection angles approximately given by the radius of the circle which defines the light-receiving area 6′ and the distance between the object or substrate 4 and the sensor 1′, 2′, which angle is in the order of 45°. Whereas exemplified by the example illustrated in the upper part of FIG. 4a), the same applies to the other examples.

FIG. 5 shows a schematic diagram which illustrates a example process of printing with the first print engine 7 on a front side of the substrate 4, and the second print engine 8 on the rear side of the substrate 4.

The process starts under the assumption that the spectrophotometric sensors 1, 2 have a basic calibration. At 100 the print engines 7, 8 are calibrated using a reference substrate as the substrate 4 so that both print identical results, e.g. for a test pattern. At 200 the first sensor 1 and the second sensor 2 are cross-calibrated by processing output signals of the sensors 1, 2 from identical spectrophotometric measurements, e.g. by spectrophotometric measurement of a specimen having identical spectral reflectivities on the front side and the rear side.

At 300 the first and second sensors 1, 2 are used for spectrophotometric measurement by receiving light reflected from the substrate 4 which is used for printing. The first and second sensors 1, 2 produce output signals which represent the spectral reflectivity of the substrate 4, wherein the first sensor 1 performs spectrophotometric measurement of the front side of the substrate 4, and the second sensor 2 performs spectrophotometric measurement of the rear side of the substrate 4, wherein the measurements are performed on the blank front and rear sides of the substrate 4.

At 400 the processing unit 3 receives the output signals of the first and second sensors 1, 2, and produces correction data which represent a deviation between the output signals from the first and second sensors 1, 2, i.e. in the spectral reflectivity of the front side and the rear side of the substrate 4. With a correction derived from the correction data applied on at least one of the first and second print engines 1, 2 the deviation in the spectral reflectivity of the front side and the rear side of the substrate 4 is compensated by the first and second print engines 7, 8. With the first and second sensors 1, 2 being cross-calibrated at 200 the spectrophotometric measurements of the front side and the rear side of the substrate 4 are performed on a common basis.

As examples, after printing the front side and the rear side of the substrate 4 with the spectral reflectivity of the front side and the rear side being compensated the printing can be continued with the same correction at the print engines 7, 8, as indicated by 600, or the spectrophotometric measurement at 300 and the compensating at 400 can be repeated before printing, as indicated by 700.

As described above, the substrate 4 is fed to the first and second print engines 7, 8 by a common feeder 9, and the first print engine prints 7 on the front side of the substrate 4 and the second print engine 8 prints on the rear side of the substrate 4. As an example, the printing is performed page-by-page, and the spectrophotometric measurement is performed on a given page, and applying the correction derived from the correction data of the given page is applied on a page following to the given page. As another example, the printing is performed page-by-page, and spectrophotometric measurement and applying the correction derived from the correction data are performed on the same page.

1. A printer with a first print engine to print on a front side of a substrate and a second print engine to print on the rear side of the substrate, comprising
a first spectrophotometer sensor and a second spectrophotometer sensor, wherein the sensors are for spectrophotometric measurement by receiving light reflected from the substrate and to produce output signals which represent a spectral reflectivity of the substrate,
wherein the first sensor is for spectrophotometric measurement of the front side of the substrate and the second sensor is for spectrophotometric measurement of the rear side of the substrate, and wherein the spectrophotometric measurements are performed on the blank front and rear sides of the substrate, and
a processing unit to receive the output signals of the first and second sensors,
to produce correction data which represent a deviation between the output signals from the first and second sensors, and
to apply a correction derived from the correction data on at least one of the first and second print engines, so that a deviation in the spectral reflectivity of at least one of the front side and the rear side of the substrate is compensated by the first and second print engines,
wherein the first and second sensors are cross-calibrated by the processing unit from output signals of the sensors from identical spectrophotometric measurements.

2. The printer according to claim 1, wherein the printer has a common feeder to feed the substrate to the first and second print engines, where the first print engine is to print on the front side of the substrate and the second print engine is to print on the rear side of the substrate.

3. The printer according to claim 1, wherein the processing unit is to cross-calibrate the first and second sensors by processing the output signals of the first and second sensors by spectrophotometric measurement of a specimen having identical spectral reflectivities on the front side and the rear side.

4. The printer according to claim 1, wherein the processing unit is to compensate the deviation in the spectral reflectivity of the front side and the rear side of the substrate.

5. The printer according to claim 1, wherein the processing unit is to compensate at least one of a deviation of the spectral reflectivity of the front side of the substrate from a reference spectral reflectivity and a deviation of the spectral reflectivity of the rear side of the substrate from a reference spectral reflectivity.

6. The printer according to claim 1, wherein the substrate from which the first and second spectrophotometer sensors receive light is an opaque material, wherein the first and second spectrophotometer sensors include a light source to illuminate the substrate, and wherein the light received by the first and second spectrophotometer sensors is reflected from the substrate.

7. The printer according to claim 1, wherein the first and second spectrophotometer sensors include a light source to illuminate the substrate, and wherein the sensors include light-receiving areas which are arranged around a centrally arranged light source so that the light source is surrounded by the light-receiving areas.

8. A method of printing with a first print engine to print on a front side of a substrate, and a second print engine to print on the rear side of the substrate,
wherein a first spectrophotometer sensor and a second spectrophotometer sensor are used for spectrophotometric measurement by receiving light reflected from the substrate, and to produce output signals which represent a spectral reflectivity of the substrate,
wherein the first sensor performs spectrophotometric measurement of the front side of the substrate, and the second sensor performs spectrophotometric measurement of the rear side of the substrate, and wherein the spectrophotometric measurements are performed on the blank front and rear sides of the substrate,
and a processing unit receives the output signals of the first and second sensors and produces correction data which represent a deviation between the output signals from the first and second sensors, and
wherein a correction derived from the correction data is applied on at least one of the first and second print engines, so that a deviation in the spectral reflectivity of at least one of the front side and the rear side of the substrate is compensated by the first and second print engines, and
wherein the method further includes cross-calibrating the first and second sensors by processing the output signals of the sensors from identical spectrophotometric measurements, and wherein the spectrophotometric measurements for compensating the deviation in the spectral reflectivity of the front side and the rear side of the substrate are performed by the cross-calibrated sensors.

9. The method according to claim 8, wherein the substrate is fed to the first and second print engines by a common feeder, where the first print engine prints on the front side of the substrate and the second print engine prints on the rear side of the substrate.

10. The method according to claim 8, wherein cross-calibrating the first and second sensors is by processing the output signals of the sensors by spectrophotometric measurement of a specimen having identical spectral reflectivities on the front side and the rear side.

11. The method according to claim 8, wherein compensating the deviation in the spectral reflectivity of the front side and the rear side of the substrate includes that a deviation of the spectral reflectivity of the front side from the spectral reflectivity of the rear side of the substrate is compensated.

12. The method according to claim 8, wherein compensating the deviation in the spectral reflectivity of the front side and the rear side of the substrate includes that at least one of a deviation of the spectral reflectivity of the front side of the substrate from a reference spectral reflectivity and a deviation of the spectral reflectivity of the rear side of the substrate from a reference spectral reflectivity is compensated.

13. The method according to claim 8, wherein the correction data are produced as a ratio or as a difference of the output signals of the first and second spectrophotometer sensors, and wherein the correction includes applying the ratio or the difference to the output signals of one of the first and second spectrophotometer sensors.

14. The method according to claim 8, wherein the substrate is fed to the first and second print engines by a common feeder, where the first print engine prints on the front side of the substrate and the second print engine prints on the rear side of the substrate, wherein the printing of the substrate is performed page-by-page, and wherein the spectrophotometric measurement is performed on a given page, and applying the correction derived from the correction data of the given page is applied on a page following the given page.

15. A method of spectrophotometric measurement, in which a first spectrophotometer sensor and a second spectrophotometer sensor are to receive light from an object and to produce output signals which represent a spectrum of the light received by the first and second spectrophotometer sensors, wherein
the output signals of the first and second sensors are processed in a processing unit,
wherein processing the output signals of the first and second sensors by the processing unit comprises
producing correction data which represent a deviation between the output signals from the first and second sensors, and
applying a correction derived from the correction data on one or both of the first and second sensors so that the sensors are cross-calibrated.
